(19) United States
(12) Patent Application Publication
(10) Pub. No.: US 2008/0266271 A1
(43) Pub. Date: Oct. 30, 2008

(54) Input System

(75) Inventors: Cornelis Van Berkel, Hove (GB); David S. George, Horsted Keynes (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,242

(22) PCT Filed: Jun. 6, 2005
(86) PCT No.: PCT/IB2005/051828

§ 371 Date: Dec. 8, 2006

(30) Foreign Application Priority Data
Jun. 9, 2004 (GB) 0412787.4

(51) Int. Cl. G06F 3/045

(52) U.S. Cl. 345/174

(57) ABSTRACT

A user input system (40) in which an output from a cross-capacitance object sensing system (30) (also known as an electric field object sensing s system) is combined with an output from a touchscreen device (15). An output from the user input system (40) may comprise position information derived from the cross-capacitance object sensing system (30) and indications of touch events derived from the touchscreen device (15). Another possibility is for sensing signals (S₁, S₂, S₃,S₄) derived from the cross-capacitance object to sensing system (30) to be processed in combination with position information derived from the touchscreen device (15) to provide updated parameters (P₁, P₂, P₃, P₄) for an algorithm used to determine position information from further sensing signals (S₁, S₂, S₃, S₄) derived from the cross-capacitance object sensing system (30).

The present invention relates to object sensing using cross-capacitance sensing. Cross-capacitance sensing is also known as electric field sensing. The present invention is particularly suited to using object sensing to provide a user interface input.

One sensing technology used for object sensing is capacitive sensing. A different sensing technology used for object sensing is cross capacitive sensing, also known as electric field sensing or quasi-electrostatic sensing.

In its very simplest form, capacitive sensing uses just one electrode and a measurement is made of the load capacitance of that electrode. This load capacitance is determined by the sum of all the capacitances between the electrode and all the grounded objects around the electrode. This is what is done in proximity sensing.

Cross-capacitance sensing, which may be termed electric field sensing, uses plural electrodes, and effectively measures the specific capacitance between two electrodes. An electrode to which electric field generating apparatus is connected may be considered to be an electric field sensing transmission electrode (or transmitter electrode), and an electrode to which measuring apparatus is connected may be considered to be an electric field sensing reception electrode (or receiver electrode). The transmitter electrode is excited by application of an alternating voltage. A displacement current is thereby induced in the receiver electrode due to capacitive coupling between the electrodes (i.e. effect of electric field lines). If an object (e.g. finger or hand) is placed near the electrodes (i.e. in the field lines) some of the field lines are terminated by the object and the capacitive current decreases.

The presence of the object is sensed by monitoring the capacitive displacement current or changes therein. For example, U.S. Pat. No. 6,025,726 discloses use of an electric field sensing arrangement as, inter-alia, a user input device for computer and other applications. The cross-capacitance sensing arrangement senses the position of a user's finger(s), hand or whole body, depending on the intended application. WO-02/103621 discloses a two-phase charge accumulation sensing circuit for monitoring the capacitive current in object sensing systems using cross-capacitance sensing. This sensing circuit may be integrated in a display.

Generally, cross-capacitance arrangements may be provided with transmission and reception electrodes positioned around a display screen thus providing a combined input/display device analogous to e.g. a capacitive touchscreen input/display device but in which the user does not need to actually touch the screen, rather just needs to place his finger near to the screen. The various transmitter and reception electrodes yield signals, e.g. in the case of two transmitters and two receivers there are a total of four signals. A processor implements a position-determining algorithm on the four signals to derive a calculated position of the object, e.g. the fingertip of a user's hand. This algorithm effectively includes compensation for the fact that the user's fingertip is in reality attached to the user's hand, which can lead to many variations such as the way in which the user holds his finger relative to his hand (which may be termed “gesture” or “hand-profile”), and the difference between different users' hands, and so on. The position-determining algorithm accommodates the different distances away from the screen that the finger may be held at (i.e. “z-axis”, if the plane of the screen is considered to be defined by an x-axis and a y-axis). Further details of such an arrangement are described in “3D Touchless Display Interaction” C van Berkel; SID Proc Int Symp, vol 33, number 2, pp 1410-1413, May 19-24, 2002, which is incorporated herein by reference.

The present inventors have realised that a significant issue with respect to the accuracy of the position-determining algorithm is that variations such as those described above (e.g. with respect to the users' gestures) may vary significantly and rapidly over time, even if the physical aspects of the sensing system are completely stable. This has lead the present inventors to realise that in this situation it would be particularly desirable to provide an adaptive process for accommodating, to at least an extent, ongoing variations caused by varying gesture and so on. Such a process may be considered to be a form of adaptive or real-time calibration adjustment, but it should be noted this is different concept to conventional fixed calibration processes performed on e.g. conventional touchscreens, which are used to compensate, for example, varying physical aspects of the touchscreen.

The present inventors have further realised that a disadvantage of cross-capacitance object sensing input devices is that they do not conventionally provide for inputting of touch events, corresponding for example to “clicks” of mouse buttons, and consequently it would be desirable to provide a touch event input capability to a cross-capacitance object sensing input device such as a combined input/display (screen) device.

In a first aspect, the present invention provides a user input system, comprising: a cross-capacitance object sensing system; a touchscreen device; the cross-capacitance object sensing system and the touchscreen device being arranged such that an input area of the cross-capacitance object sensing system corresponds substantially to a display and input area of the touchscreen device; and processing means for combining an output derived from the cross-capacitance object sensing system with an output derived from the touchscreen.

In a further aspect, the processing means may be arranged for using an algorithm to determine position information from sensing signals derived from the cross-capacitance object sensing system; and the processing means may be further arranged for combining sensing signals derived from the cross-capacitance object sensing system with position information derived from the touchscreen to provide updated parameters for the algorithm to use when determining position information from further sensing signals derived from the cross-capacitance object sensing system.

In a further aspect, the processing means may be arranged for processing inputs in terms of sub-areas of the input area of the cross-capacitance object sensing system; and such that updated parameters are provided for the algorithm dependent upon the sub-area from which the position information is derived from the touchscreen.

In a further aspect, the processing means may be arranged for providing an output from the user input system comprising position information derived from the cross-capacitance object sensing system and indications of touch events derived from the touchscreen device.

In a further aspect, the processing means may be arranged for providing an output from the user input system comprising position information, derived from the cross-capacitance object sensing system and the touchscreen device, and indications of touch events derived from the touchscreen device.

In a further aspect, the present invention provides a method of processing user input, comprising: providing an output from a cross-capacitance object sensing system; providing an output from a touchscreen device; the cross-capacitance object sensing system and the touchscreen device being arranged such that an input area of the cross-capacitance object sensing system corresponds substantially to a display and input area of the touchscreen device; and combining the output derived from the cross-capacitance object sensing system with the output derived from the touchscreen device.

In a further aspect, the output from the cross-capacitance object sensing system comprises sensing signals; and the output from the touchscreen device comprises position information; the method further comprising: processing the sensing signals in combination with the position information output from the touchscreen device to provide updated parameter values for use in a position-determining algorithm; and using the position-determining algorithm with the updated parameter values to provide position information from further sensing signals provided by the cross-capacitance object sensing system.

In a further aspect, user inputs may be processed in terms of sub-areas of the input area of the cross-capacitance object sensing system; and the updated parameters are provided for the algorithm dependent upon the sub-area from which the position information is derived from the touchscreen.

In a further aspect, the method further comprises providing an output from the user input system comprising position information derived from the cross-capacitance object sensing system and indications of touch events derived from the touchscreen device.

In a further aspect, the method further comprises providing an output from the user input system comprising position information, derived from the cross-capacitance object sensing system and the touchscreen device, and indications of touch events derived from the touchscreen device.

In a further aspect, the present invention provides a processor adapted to process sensing signals from a cross-capacitance object sensing system and position information from a touchscreen device to provide updated parameters for use in an algorithm for determining position information from further sensing signals from the cross-capacitance object sensing system.

In further aspects, the present invention provides a user input system in which an output from a cross-capacitance object sensing system (also known as an electric field object sensing system) is combined with an output from a touchscreen device, for example an electrostatic touchscreen device. An output from the user input system may comprise position information derived from the cross-capacitance object sensing system and indications of touch events derived from the touchscreen device. Another possibility is for sensing signals derived from the cross-capacitance object sensing system to be processed in combination with position information derived from the touchscreen device to provide updated parameters for an algorithm used to determine position information from further or later sensing signals derived from the cross-capacitance object sensing system.

Thus an updated, ongoing calibration process is provided for the cross-capacitance object sensing system, the process using approximately simultaneous or corresponding position information from the touchscreen device and the cross-capacitance object sensing system.

Embodiments of the present invention will now be described, by way of example, with reference to the accompanying drawings, in which:

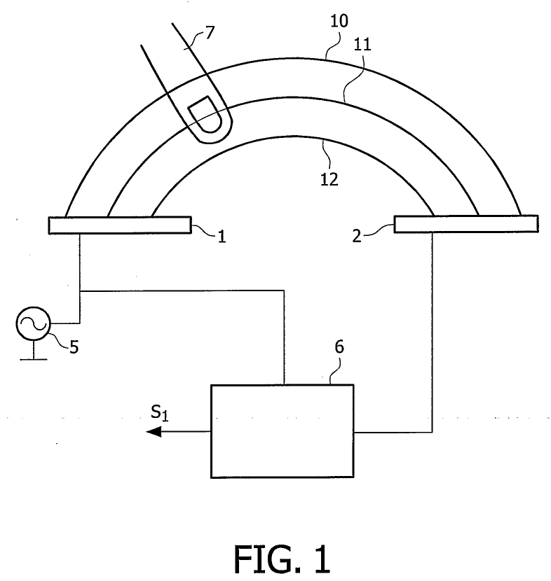

FIG. 1 is a schematic illustration (not to scale) showing part of a cross-capacitance (also known as electric field) object sensing arrangement;

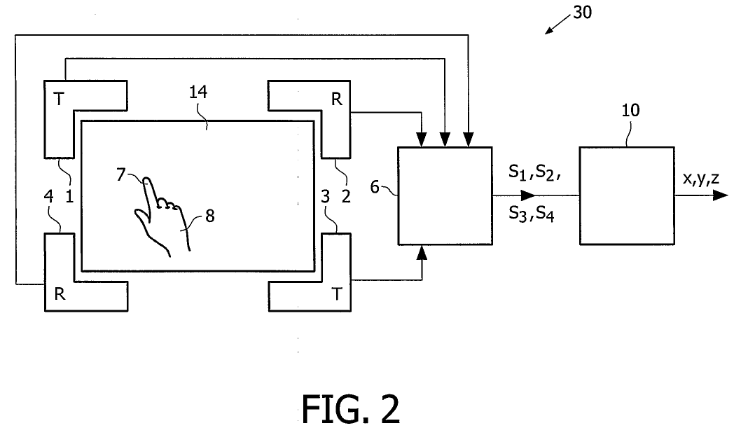

FIG. 2 is a schematic illustration (not to scale) showing further details of the cross-capacitance object sensing arrangement of FIG. 1;

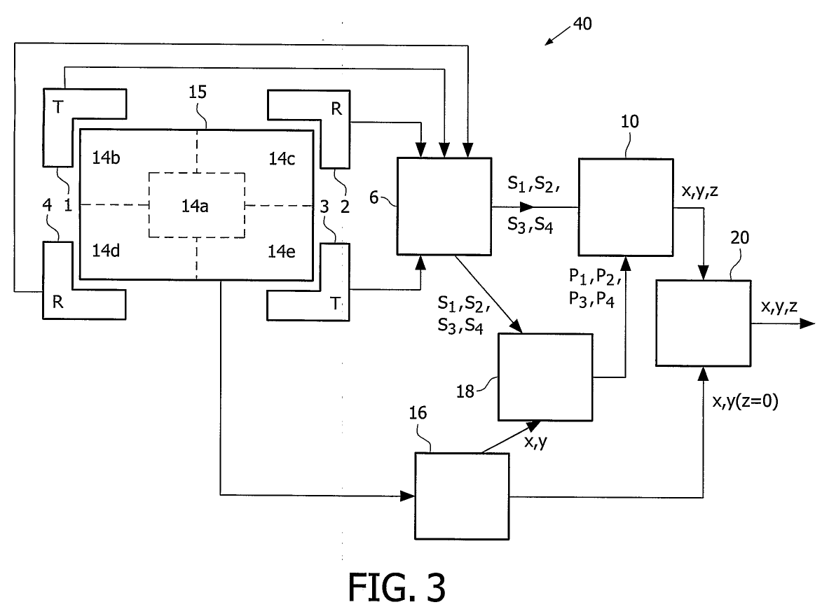

FIG. 3 is a schematic illustration (not to scale) showing a user input system comprising the cross-capacitance object sensing arrangement of FIG. 1; and

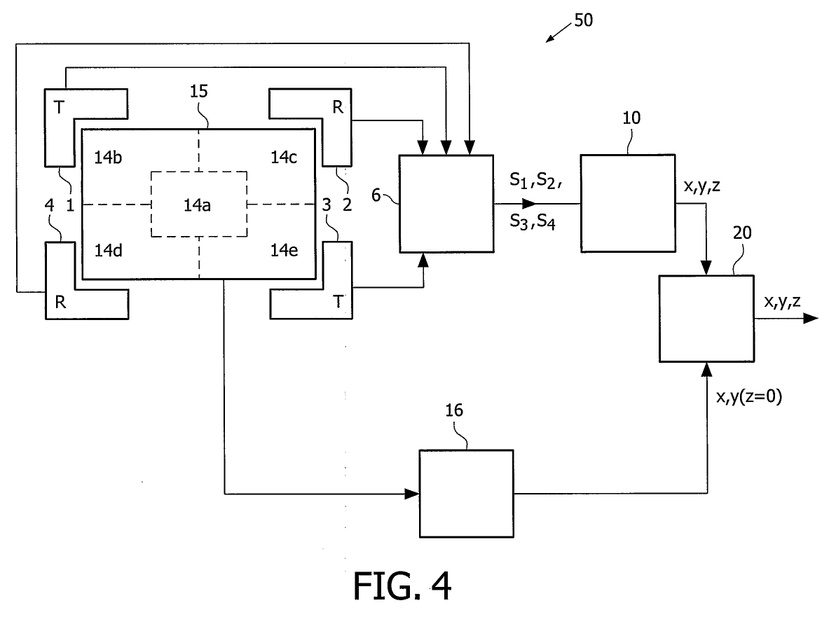

FIG. 4 is a schematic illustration (not to scale) of a user input system.

FIG. 1 is a schematic illustration (not to scale) showing part of a cross-capacitance (also known as electric field) object sensing arrangement (i.e. system) employed in a first embodiment. The arrangement comprises a transmitter electrode 1, an alternating voltage source 5, a receiver electrode 2, and a processor 6, hereinafter referred to as a cross-capacitance processor 6. The cross-capacitance processor 6 comprises a current sensing circuit.

The alternating voltage source 5 is connected to the transmitter electrode 1. The cross-capacitance processor 6 is connected to the receiver electrode 2.

In operation, when an alternating voltage is applied to the transmitter electrode 1, electric field lines are generated, of which exemplary electric field lines 10, 11, 12 pass through the receiver electrode 2 (note for convenience the field lines are shown in FIG. 1 as being only in the plane of the paper, but in practise they form a three-dimensional field extending also out of the paper). The field lines 10, 11, 12 induce a small alternating current at the receiver electrode 2.

When an object 7, e.g. a finger, is placed in the vicinity of the two electrodes 1, 2, the object 7 in effect terminates those field lines (in the situation shown in FIG. 1, field lines 10 and 11) that would otherwise pass through the space occupied by the object 7, thus reducing the cross-capacitive effect between the two electrodes 1, 2 e.g. reducing the current flowing from the receiver electrode 2. More strictly speaking, the hand shields the electrodes from each other and this is illustrated by a distortion (termination) of the field lines around the hand. The decrease in alternating current is measured using the current sensing circuit of the cross-capacitance processor 6, with the current sensing circuit using a tapped off signal from the alternating voltage to tie in with the phase of the electric field induced current. Thus the current level measured by the current sensing circuit is a measure of the presence, form and location of the object 7 relative to the positions of the two electrodes 1, 2. This current level is processed to provide a sensing signal s₁ derived from the transmitter/receiver electrode pair provided by the transmitter electrode 1 and the receiver electrode 2.

FIG. 2 is a schematic illustration (not to scale) showing further details of the cross-capacitance object sensing arrangement 30 employed in the first embodiment. In this embodiment the cross-capacitance object sensing arrangement 30 comprises two transmitter electrodes, namely the transmitter electrode 1 shown in FIG. 1 and a further transmitter electrode 3, and two receiver electrodes, namely the receiver electrode 2 shown in FIG. 1 and a further receiver electrode 4. The four electrodes are positioned at the four corners of a display and input area 14. The two transmitter electrodes are at opposing corners, and hence also the two receiver electrodes are at opposing corners. Each of the transmitter electrodes 1, 3 and the receiver electrodes 2, 4 are connected to the cross-capacitance processor 6, which in turn has an output connected to a position-determining algorithm processor 10.

This arrangement provides four different transmitter/receiver electrode pairs: transmitter electrode 1 with receiver electrode 2 (the pair shown in FIG. 1); transmitter electrode 1 with receiver electrode 4; transmitter electrode 3 with receiver electrode 2; and transmitter electrode 3 with receiver electrode 4. Each of these pairs provides a respective sensing signal, hence in this embodiment there are four sensing signals s₁, s₂, s₃, s₄ provided as an output from the cross-capacitance processor 6.

The levels or values of the four sensing signals s₁, s₂, s₃, s₄ depend upon the position of the user's finger 7 being used to point or move in the vicinity of the display and input area 14. These values are output from the cross-capacitance processor 6 to the position-determining algorithm processor 10. The four sensing signals s₁, s₂, s₃, s₄ together form a set of sensing signals which may be represented by a vector s.

The position-determining algorithm processor 10 uses an algorithm to determine, from the values of the sensing signals s₁, s₂, s₃, s₄, a position in terms of co-ordinates x, y, z, for the finger 7 (more precisely, the tip of the finger 7). The position in terms of co-ordinates x, y, z may be represented by a vector x. The position-determining algorithm is characterised by a set of parameters, hereinafter referred to as the algorithm parameters, which together may be represented by a vector p. In this embodiment the set of algorithm parameters contains 4 algorithm parameters p₁, p₂, p₃, p₄.

Furthermore the position-determining algorithm itself may be represented by an operator A(p,•) such that the position to be determined is given as: x=A(p,s)

The cross-capacitance object sensing arrangement 30 shown in FIG. 2 has additionally been provided with a touchscreen and further processing elements to alleviate effects due to variations in a user's hand profile or gesture in relation to the intended finger tip position of the user, as will now be explained with reference to FIGS. 3 and 4.

FIG. 3 is a schematic illustration (not to scale) showing a user input system of the first embodiment, comprising the cross-capacitance object sensing arrangement 30 and further elements, including a touchscreen and related processing elements.

The user input system 40 comprises the elements and arrangement, indicated by the same reference numerals, of the cross-capacitance object sensing arrangement 30 described above with reference to FIG. 2, namely the transmitter electrodes 1, 3; the receiver electrodes 2, 4; the cross-capacitance processor 6 and the position-determining algorithm processor 10.

In addition, the user input system 100 further comprises a touchscreen display 15; a touchscreen processor 16; a calibration processor 18; and an output processor 20.

The touchscreen display 15 is coupled to the touchscreen processor 16. The touchscreen processor 16 is further coupled to the calibration processor 18 and the output processor 20. The calibration processor 18 and the output processor 20 are each further coupled to the position-determining algorithm processor 10.

The touchscreen display 15 is a combined input and display device, in this example a conventional capacitive sensing touchscreen. The area of the touchscreen display 15 substantially corresponds to the display and input area 14 described above with reference to FIG. 2. FIG. 3 shows the area of the touchscreen display 15 divided into five sub-areas, i.e. a central area 14a, and four further quadrant-type sub-areas 14b, 14c, 14d, 14e dividing the remaining area into four quadrants, one at each corner of the display and input area 14. The sub-areas are not physically differentiated; rather processing operations carried out by the touchscreen processor 16 depend upon these sub-areas, as will be described in more detail below.

Operation of the user input system 40 will now be described. When the user's finger 7 touches the surface of the touchscreen display 15, the resulting signals output from the touchscreen display 15 are input to the touchscreen processor 16. In conventional fashion, the touchscreen processor determines the position, in terms of x and y co-ordinates, on the screen where the user's finger 7 touched the surface. The position, i.e. x and y values, are output from the touchscreen processor 16 to the calibration processor 18 and also to the output processor 20.

The earlier described sensing signals s₁, s₂, s₃, s₄ output from the cross-capacitance processor 6 are input to the calibration processor 18. (This takes place in addition to the earlier described inputting of the sensing signals s₁, s₂, s₃, s₄ to the position-determining algorithm processor 10.) Thus the calibration processor 18 receives both the sensing signals s₁, s₂, s₃, s₄ from the cross-capacitance processor 6 and the x,y position information from the touchscreen processor 16; i.e. the calibration processor 18 receives respective signals derived substantially simultaneously for a given finger and hand position from both the touchscreen display 15 and the cross-capacitance object sensing arrangement 30.

The calibration processor 18 treats the x,y position information from the touchscreen processor 16 as an up-to-date “calibration point” (this term will be described in more detail below).

The calibration processor 18 then uses this up-to-date calibration point in combination with the sensing signals s₁, s₂, s₃, s₄ that were provided by the cross-capacitance processor 6 at the time of the finger 7 touching the touchscreen display 15 to determine updated values for the algorithm parameters p₁, p₂, p₃, p₄, as will be described in more detail below. The calibration processor 18 then outputs these updated values for the algorithm parameters p₁, p₂, p₃, p₄, to the position-determining algorithm processor 10.

Thereafter, e.g. until a further update for the values for the algorithm parameters p₁, p₂, p₃, p₄, is provided as a result of the user's finger again touching the surface of the touchscreen display 15, the updated values for the algorithm parameters p₁, p₂, p₃, p₄, are used by the position-determining algorithm processor when determining the position in terms of co-ordinates x, y, z, for the finger 7 (more precisely, the tip of the finger 7).

The position x,y,z position determined by the position-determining processor 10 is output to the output processor 20. In the times between the user's finger 7 touching the surface of the touchscreen display 15, this x,y,z position received from the position-determining algorithm processor 10 is output by the output processor 20 as the position value output from the user input system 40. However, at times when the user's finger 7 touches the touchscreen display 15, the x,y position determined by the touchscreen processor 16 is output from the touchscreen processor 16 to the output processor 20, and is output by the output processor 20 as the position value output from the user input system 40; i.e. in this embodiment, when the value of z=0 the output processor 20 outputs the touchscreen values for x,y rather than the cross-capacitance object sensing values for x,y. However, in other embodiments the x,y,z position received from the position-determining algorithm processor 10 is output by the output processor 20 as the position value output from the user input system 40 irrespective of whether a separate value for x,y is available from the touchscreen processor 16.

Further details of the calibration points and the operating parameters will now be described. As described above, each calibration point corresponds to an x,y position provided by the touchscreen processor 16 for which substantially simultaneous sensing signals s₁, s₂, s₃, s₄ from the cross-capacitance processor 6 are provided. The calibration points are used by the calibration processor 18 to derive the algorithm parameters p₁, p₂, p₃, p₄. In this embodiment, 5 calibration points are used and there are 4 algorithm parameters. Other numbers of algorithm parameters and/or calibration points may be used in other embodiments.

As described above, the calibration points (and hence the operating parameters) are updated as the user uses the user input system 40. Initial values for the operating parameters may be provided in any suitable manner. In this embodiment, pre-determined nominal calibration points x,y each with a respective corresponding pre-determined set of values for the sensing signals s₁, s₂, s₃, s₄ are stored in storage means associated with the calibration processor. Some of the predetermined nominal calibration points will correspond to finger locations that are far away, i.e. when the signals are at their maximum value, x and y are given nominal values x=0, y=0 and the z is given a nominal large value (say 2 times the screen width above the screen). These points are to give the parameterised operator range in the z direction and are typically never replaced during user interaction, although the system could replace them if it detects that there is nobody near the apparatus. More generally, such typically never to be replaced nominal values could be used for a number of x,y,z locations. These pre-stored values are used by the calibration processor to provide initial values for the operating parameters p₁, p₂, p₃, p₄ which are used by the user input system 40 until a new set of operating parameter values p₁, p₂, p₃, p₄ is determined as a result of an updated calibration point/sensing signal set being formed due to the user touching the screen. In other embodiments, initial values of the operating parameters themselves may be stored and used.

In this embodiment, the five calibration points are provided such that there is a respective calibration point provided from each of the five sub-areas 14a-e of the display and input area 14. In this embodiment, each time an updated calibration point is determined, the calibration processor 18 further determines which of the sub-areas 14a-e the updated calibration point applies to, and then replaces the existing calibration point for that sub-area 14a-e with the updated calibration point. However, many other schemes or criteria may be used for determining which, if any, of the current calibration points to replace with an updated calibration point, and these be described later below.

Further details of the calibration points, operating parameters and position-determining algorithm will now be described.

Calibration is provided by pairs of known positions xᵢ and known signals sᵢ. For instance (x₁, sᵢ), (x₂, s₂), . . . (xₖ, sₖ). Note sᵢ (bold text) is a vector, whereas the earlier described sᵢ is an element in a vector. The process finds the parameter vector p (i.e. set of operating parameters p₁, p₂, p₃, p₄) which minimizes the error in the positions predicted by the earlier described operator A(p,•) and the known calibration positions, i.e. (There is a small mistake in the equation, I've put in a corrected version, can you spot the difference?)

$${min}_{p} {\sum }_{i = 1}^{k} {( A ( p , {\underline{x}}_{i} ) - {s}_{i} )}^{2}$$

which is implemented by analytical techniques (alternatively numerical techniques may be employed, or a combination of analytical and numerical techniques). The resulting parameter vector p (i.e. set of operating parameters p₁, p₂, p₃, p₄) is stored and used in the calculation of x from s.

In this embodiment, there are four sensing signals s₁, s₂, s₃, s₄ constituting the signal vector s. The algorithm extracting the position from that is given by

$$x = c ( \begin{matrix}0 & 1 & - 1 & 0 \\ 1 & 0 & 0 & - 1 \\ 1 & 1 & 1 & 1\end{matrix} ) s + {x}_{0} = Bs + {x}_{0}$$

in which the signal vector s is normalised with respect to the maximum signals, i.e. its elements take on values between 0 and 1. The scalar c and the elements x₀, y₀, z₀ of the offset vector x₀ are the four operating parameters that characterise the calibration in this example. Using p₁=c, p₂=x₀, p₃=y₀, p₄=z₀, we can write the equation as

$$x = ( \begin{matrix}{s}_{2} - {s}_{3} & 1 & 0 & 0 \\ {s}_{1} - {s}_{4} & 0 & 1 & 0 \\ {s}_{1} + {s}_{2} + {s}_{3} + {s}_{4} & 0 & 0 & 1\end{matrix} )$$

$$p = ( Bs \vert I ) p$$

This shows that this is an equation which can be solved for p. With multiple calibration points (in this example 5) we get

$$( \begin{matrix}{\underline{x}}_{1} \\ {\underline{x}}_{2} \\ ⋮\end{matrix} ) = ( \begin{matrix}{Bs}_{1} \vert & I \\ {Bs}_{2} \vert & I \\ ⋮ & \end{matrix} ) p$$

This system of equations can be solved (for instance) with standard mathematical techniques such as the Moore-Penrose generalised inverse, which for this example is given by

$$p = {[ ( \frac{{( {Bs}_{1} )}^{T}}{I} \frac{{( {Bs}_{1} )}^{T}}{I} … ) ( \begin{matrix}{Bs}_{1} \vert & I \\ {Bs}_{2} \vert & I \\ ⋮ & \end{matrix} ) ]}^{- 1} ( \frac{{( {Bs}_{1} )}^{T}}{I} \frac{{( {Bs}_{1} )}^{T}}{I} … ) ( \begin{matrix}{\underline{x}}_{1} \\ {\underline{x}}_{2} \\ ⋮\end{matrix} )$$

This process is automated in conventional fashion.

Further embodiments will now be considered. In the above described embodiment the output processor 20 provides an output comprising an x,y,z position. In other embodiments, when the user's finger 7 has touched the touchscreen display 15, thereby providing a new output from the touchscreen processor 16 as described above, the output processor 20 includes in its output signal an indication that a touch event has taken place at the particular x,y position. This touch event output is analogous or equivalent to a click being output when a conventional mouse is used as part of a user input system.

A second main embodiment will now be described with reference to FIG. 4. FIG. 4 is a schematic illustration (not to scale) of a user input system 50 of the second main embodiment. The user input system 50 includes all of the elements of the earlier described user input system 40, with the same parts indicated by the same reference numerals, except that this user input system 50 does not comprise the calibration processor 18 of the earlier described user input system 40.

The cross-capacitance processor 6 and the position-detecting algorithm processor 10 operate as described earlier to provide x,y,z position data to the output processor 20. There is no updating of the operating parameters p₁, p₂, p₃, p₄, instead just one initial set is used. In this second embodiment, when the user's finger 7 has touched the touchscreen display 15, thereby providing a new output from the touchscreen processor 16 as described above, the output processor 20 includes in its output signal an indication that a touch event has taken place at the particular x,y position. This touch event output is analogous or equivalent to a click being output when a conventional mouse is used as part of a user input system. In other words, in this embodiment, the touchscreen display 15 and touchscreen processor 16 provide touch event detection, but do not provide updating of calibration points of the cross-capacitance object sensing arrangement 30. In this embodiment, the touchscreen processor 16 provides x,y position information to the output processor 20. The output processor 20, in addition to indicating a touch event in the output, uses the x,y position provided by the touchscreen processor 16 as the position value output from the user input system 40, i.e. when the value of z=0 the output processor 20 outputs the touchscreen values for x,y rather than the cross-capacitance object sensing values for x,y. However, another possibility is to use the touchscreen processor output merely for the purpose of indicating a touch event, with such an indication being included in the output from the output processor 20, but keeping the output processor's position output based entirely on the position information received from the position-detecting algorithm processor 10 of the cross capacitance object sensing system arrangement 30.

In the embodiment described above, the schemes or criteria for determining which, if any, of the current calibration points to replace with an updated calibration point is simply that each updated calibration point replaces the current calibration point of the appropriate sub-area. However, in other embodiments, other schemes or criteria may be used for determining which, if any, of the current calibration points to replace with an updated calibration point.

One possibility is that in addition to replacing the calibration points on the basis of the sub-areas, criteria based on timing may be employed. For example, one additional criterion may be that a current calibration point is only replaced if more than a predetermined amount of time has passed since the current calibration point was itself made the current calibration point for the particular sub-area; another possibility is that the only calibration point that may be updated is that for the sub-area that has had its current calibration point the longest.

More generally, the sub-areas may be arranged differently to the embodiment described above, e.g. the display and input area 14 may be divided into 4 quarters, or e.g. 9 sub-areas arranged in a 3×3 matrix.

Another possibility is that the choice of which if any calibration point to update may be based on criteria unrelated to dividing the display and input area into sub-areas. For example, the current calibration points may be updated on just a time basis, for example in a scheme in which a new updated calibration point replaces the oldest of the current calibration points. Such a scheme may also additionally include an absolute time aspect, e.g. the oldest calibration point is replaced, but only if it itself has been in use for at least a predetermined amount of time.

Another possibility is to measure or determine the amount of noise on the sensing signals s₁, s₂, s₃, s₄ as a function of the place or time of the user's finger touching the screen. Then criteria based on this may be employed, for example a new calibration point if the x,y position of the user's touch corresponds to an area of the screen determined as being prone to noisy signals. Another possibility is that the current calibration points may be ranked according to how noisy the sensing signals are at their respective x,y positions for which they are derived, and a that corresponding to the noisiest location is the one replaced by a new updated calibration point.

Furthermore, the above criteria or schemes may be used in combination. For example, sub-areas may be used, and in each sub-area there is a plurality of calibration points. Then, a new calibration point replaces a calibration point in the appropriate sub-area only, but the criterion for which of the current calibration points in that sub-area to replace mat be based on one of the time-based or other criterion discussed above for the whole display and input area.

In the above embodiments the output from the touchscreen display 15 is used to update calibration of the simultaneously operating cross-capacitance object sensing system arrangement 30. This is different from routine calibration of e.g. the touchscreen display 15 itself. Indeed, this point is emphasised by the aspect that in the above described embodiments the touchscreen display 15 may be calibrated in conventional fashion in any suitable manner. For example, the touchscreen display may be calibrated during manufacture, or may comprise a user calibration facility in which a user is prompted to touch specified image points. It should be noted that the requirement and form of such processes is independent of the use of the touchscreen display 15 for providing an ongoing calibration process of the cross-capacitance object sensing system arrangement 30 in the embodiments described above.

In the above described embodiments a particular cross-capacitance electrode arrangement is employed, comprising two transmitter electrodes and two receiver electrodes positioned at the four corners of the display and input area. However, in other embodiments, other electrode arrangements and layouts, including the possibility of other numbers of electrodes, may be used. This may also provide different numbers of sensing signals compared to the four sensing signals s₁, s₂, s₃, s₄ of the embodiments described above.

In the above described embodiments a particular example of a position-determining algorithm is used. However, in other embodiments, other position-determining algorithms may be used. Consequently, in such embodiments the form or interrelation of the operating parameters and/or sensing signals may also vary compared to those described above.

In the above embodiments the touchscreen display is a capacitive sensing touchscreen. However, in other embodiments other types of touchscreen devices may be employed.

In the above described embodiments the various processors are as described and arranged as described. However, in other embodiments the processes carried out by them may be carried out by one or more other processors, or processor arrangements or systems, other than those described above. For example, some or all of the above described processors may be implemented in one central processor.

In the above embodiments the updating of the calibration points is performed continuously whenever the user input system 40 is in use. However, in other embodiments, the updating of the calibration points may only be carried out intermittently. For example, the updating of calibration points may be carried out at regular periods; or after a given settling time on turning on of the apparatus; or after a given number of touch events, e.g. every tenth touch of the touchscreen, say; or may be a facility that may be selected or deselected by the user.

In certain of the embodiments described above, the touchscreen display 15 and touchscreen processor 16 are used to provide indication of touch events and position information used to update the calibration points used by the position-detecting algorithm processor 10 of the cross capacitance object sensing system arrangement 30. However, in other embodiments, the touchscreen display 15 and touchscreen processor 16 are used to provide indication of touch events, but the position information is not used to update the calibration points used by the position-detecting algorithm processor 10 of the cross capacitance object sensing system arrangement 30. One such embodiment will now be described with reference to FIG. 4.

FIG. 4 is a schematic illustration (not to scale) of a user input system user input system 50. The user input system 50 includes all of the elements of the earlier described user input system 40, with the same parts indicated by the same reference numerals, except that this user input system 50 does not comprise the calibration processor 18 of the earlier described user input system 40. The cross-capacitance processor 6 and the position-detecting algorithm processor 10 operate as described earlier to provide x,y,z position data to the output processor 20. There is no updating of the operating parameters p₁, p₂, p₃, p₄, instead just one initial set is used. In this embodiment, when the user's finger 7 has touched the touchscreen display 15, thereby providing a new output from the touchscreen processor 16 as described above, the output processor 20 includes in its output signal an indication that a touch event has taken place at the particular x,y position. This touch event output is analogous or equivalent to a click being output when a conventional mouse is used as part of a user input system. In other words, in this embodiment, the touchscreen display 15 and touchscreen processor 16 provide touch event detection, but do not provide updating of calibration points of the cross-capacitance object sensing arrangement 30. In this embodiment, the touchscreen processor 16 provides x,y position information to the output processor 20. The output processor 20, in addition to indicating a touch event in the output, uses the x,y position provided by the touchscreen processor 16 as the position value output from the user input system 40, i.e. when the value of z=0 the output processor 20 outputs the touchscreen values for x,y rather than the cross-capacitance object sensing values for x,y. However, another possibility is to use the touchscreen processor output merely for the purpose of indicating a touch event. The touch event indication is included in the output from the output processor 20, however the output from the output processor 20 is based entirely on the position information received from the position-detecting algorithm processor 10 of the cross capacitance object sensing system arrangement 30.

1. A user input system (40), comprising:
a cross-capacitance object sensing system (30);
a touchscreen device (15);
the cross-capacitance object sensing system (30) and the touchscreen device (15) being arranged such that an input area of the cross-capacitance object sensing system (30) corresponds substantially to a display and input area (14) of the touchscreen device (15); and
processing means for combining an output derived from the cross-capacitance object sensing system (30) with an output derived from the touchscreen device (15).

2. A system according to claim 1, wherein the processing means are arranged for using an algorithm to determine position information from sensing signals (s₁, s₂, s₃, s₄) derived from the cross-capacitance object sensing system (30); and
the processing means are further arranged for combining sensing signals (s₁, s₂, s₃, s₄) derived from the cross-capacitance object sensing system (30) with position information (x, y) derived from the touchscreen device (15) to provide updated parameters (p₁, p₂, p₃, p₄) for the algorithm to use when determining position information (x, y, z) from further sensing signals (s₁, s₂, s₃, s₄) derived from the cross-capacitance object sensing system (30).

3. A system according to claim 1, wherein the processing means are arranged for processing inputs in terms of sub-areas (14a-e) of the input area of the cross-capacitance object sensing system (14); and such that updated parameters (p₁, p₂, p₃, p₄) are provided for the algorithm dependent upon the sub-area (14a-e) from which the position information (x, y) is derived from the touchscreen device (15).

4. A system according to claim 1, wherein the processing means are arranged for providing an output from the user input system comprising position information (x, y, z) derived from the cross-capacitance object sensing system (30) and indications of touch events derived from the touchscreen device (15).

5. A system according to claim 1, wherein the processing means are arranged for providing an output from the user input system comprising position information (x, y, z), derived from the cross-capacitance object sensing system (30) and the touchscreen device (15), and indications of touch events derived from the touchscreen device (15).

6. A method of processing user input, comprising:
providing an output from a cross-capacitance object sensing system (30); providing an output from a touchscreen device (15);
the cross-capacitance object sensing system (30) and the touchscreen device (15) being arranged such that an input area of the cross-capacitance object sensing system (14) corresponds substantially to a display and input area of the touchscreen device; and
combining the output derived from the cross-capacitance object sensing system (30) with the output derived from the touchscreen device (15).

7. A method according to claim 6, wherein:
the output from the cross-capacitance object sensing system (30) comprises sensing signals (s₁, s₂, s₃, s₄); and
the output from the touchscreen device (15) comprises position information (x, y); the method further comprising:
processing the sensing signals (s₁, s₂, s₃, s₄) in combination with the position information (x, y) output from the touchscreen device (15) to provide updated parameter values (p₁, p₂, p₃, p₄) for use in a position-determining algorithm; and
using the position-determining algorithm with the updated parameter values (p₁, p₂, p₃, p₄) to provide position information (x, y, z) from further sensing signals (s₁, s₂, s₃, s₄) provided by the cross-capacitance object sensing system (30).

8. A method according to claim 6, wherein user inputs are processed in terms of sub-areas (14a-e) of the input area (14) of the cross-capacitance object sensing system (30); and the updated parameters (p₁, p₂, p₃, p₄) are provided for the algorithm dependent upon the sub-area (14a-e) from which the position information (x, y) is derived from the touchscreen device (15).

9. A method according to claim 6, further comprising providing an output from the user input system comprising position information (x, y, z) derived from the cross-capacitance object sensing system (30) and indications of touch events derived from the touchscreen device (15).

10. A method according to claim 6, further comprising providing an output from the user input system comprising position information (x, y, z), derived from the cross-capacitance object sensing system (30) and the touchscreen device (15), and indications of touch events derived from the touchscreen device (15).

11. A processor adapted to process sensing signals (s₁, s₂, s₃, s₄) from a cross-capacitance object sensing system (30) and position information (x, y) from a touchscreen device (15) to provide updated parameters (p₁, p₂, p₃, p₄) for use in an algorithm for determining position information (x, y, z) from further sensing signals (s₁, s₂, s₃, s₄) from the cross-capacitance object sensing system (30).
